(19) United States
(12) Patent Application Publication
(10) Pub. No.: US 2010/0328774 A1
(43) Pub. Date: Dec. 30, 2010

(54) RESONANT REFLECTIVE FILTER AND BIOSENSOR INCLUDING THE SAME

(75) Inventors: Jongcheol Hong, Daejeon (KR); Jaeheon Shin, Daejeon (KR); Kyung-Hyun Kim, Daejeon (KR); Chul Huh, Daejeon (KR); Gun-Yong Sung, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/517,773

(22) PCT Filed: Dec. 5, 2007
(86) PCT No.: PCT/KR07/06283

§ 371 Date: Jun. 4, 2009

(30) Foreign Application Priority Data
Dec. 5, 2006 (KR) 10-2006-0122570
May 4, 2007 (KR) 10-2007-0043802

(51) Int. Cl. G02B 5/28; G02B 5/18

(52) U.S. Cl. 359/568

(57) ABSTRACT

Provided is a resonant reflective filter including a substrate and a grating layer, wherein the substrate is formed of a material having a lower reflective index than that of a material forming the grating layer. Thus, the resonant reflective filter can form a resonant spectrum having good symmetry and a sharp shape. Accordingly, the resonant reflective filter can have improved sensitivity and can be applied to optical systems that require a small linewidth.

### TECHNICAL FIELD

This application claims the benefit of Korean Patent Application No. 10-2006-0122570, filed on Dec. 5, 2006 and Korean Patent Application No. 10-2007-0043802, filed on May 4, 2007 in the Korean Intellectual Property Office, the disclosure of which are incorporated herein in their entirety by reference.

The present invention relates to a resonant reflective filter and a biosensor using the same, and more particularly, to a resonant reflective filter having increased sensitivity which can be applied to an optical system that requires a narrow linewidth, and a biosensor using the resonant reflective filter. This work was supported by the IT R&D program of MIC/IITA [2006-S-007-01, Ubiquitous Health Monitoring Module and System Development].

### BACKGROUND ART

A biosensor is an apparatus or a device that detects materials related to biological phenomena such as DNAs, cells, or proteins (e.g., antigens and antibodies) and measures the amount of the materials, and is applied in various fields such as disease diagnosis, development of new medicaments, environmental monitoring, food safety, etc. Recently, a label-free biosensor has been actively developed, requiring relatively simple sample preparation in comparison to a conventional biosensor that detects bio-materials by attaching marks such as radioactive isotopes or phosphor materials to the biomaterials.

In particular, optical biosensors such as surface plasmon resonant biosensors, light waveguide biosensors, interferometer biosensors, etc. have become prominent. These optical biosensors detect optical characteristics changed by biochemical reactions such as an antigen-antibody reaction that occurs on a surface of the biosensor.

Among these optical biosensors, a biosensor using a resonant reflective filter is expected to form a highly sensitive biosensor using reflection light and/or transmission light with a spectrum having a sharp peak generated by the resonant reflective filter.

A resonant reflective filter uses a principle that light diffracted by a diffraction lattice having a high refractive index is coupled with a mode that is waveguided through a waveguide having a high refractive index, thus obtaining intense and sharp resonant reflective spectrums of light.

However, conventional biosensors using a resonant reflective filter have reflective spectrums that are rather broad and asymmetric as illustrated in FIG. 1. FIG. 1 illustrates a reflective spectrum formed using a conventional resonant reflective filter. Such asymmetry of the spectrums decreases signal-to-noise ratio due to the increase of the background noise of signals. Moreover, since the refractive index of the diffraction lattice that functions as a core has to be increased in order to provide resonance by forming a light waveguide, a material having a high refractive index such as a silicon nitride or titania needs to be coated.

Accordingly, a resonant reflective filter having a reflective spectrum with a sharp and symmetric peak is highly demanded in order to enable manufacture of a sensitive biosensor.

### DISCLOSURE OF INVENTION

### Technical Problem

The present invention provides a resonant reflective filter that can be applied to an optical system requiring a small linewidth and that can be used to manufacture a biosensor having improved sensitivity compared to a conventional biosensor.

The present invention also provides a biosensor with improved sensitivity using the resonant reflective filter.

### Technical Solution

According to an aspect of the present invention, there is provided a resonant reflective filter comprising: a substrate having a first refractive index; and a grating layer formed on the substrate and having a second refractive index, wherein the second refractive index is greater than the first refractive index.

The first refractive index may be 1.24 to 1.38. The second refractive index may be 1.4 to 2.5.

The substrate may comprise at least one of the group consisting of polytetrafluoroethylene (PTFE), polymethyl methacrylate (PMMA), polymer resin obtained by polymerizing monomers having a structure of any one of Formulas 1 through 6 below, a polymer material having a repeating structure of any one of Formulas 7 through 10 below, a polymer material in which the repeating structure of Formula 9 and the repeating structure of Formula 10 are block-copolymerized, and a polymer material in which repeating structures having different R values of Formula 10 are block-copolymerized.

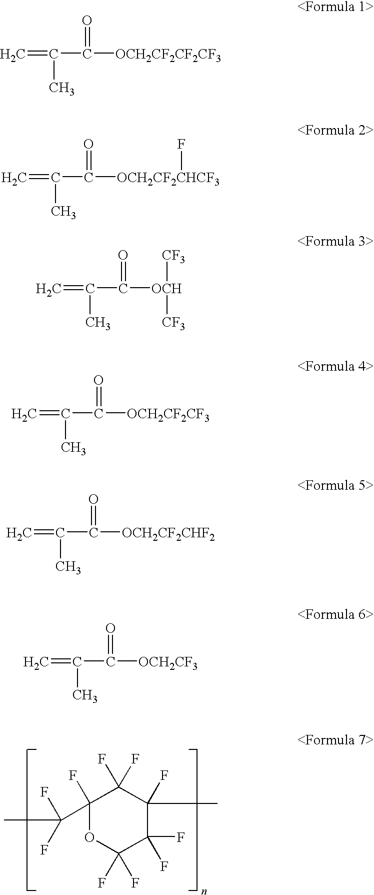

where n is an integer of 100 to 500.

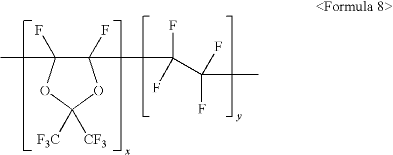

where x and y are integers of 50 to 300, respectively.

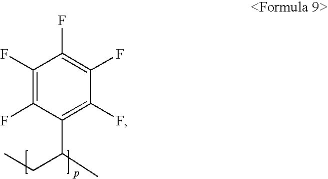

where p is an integer of 50 to 500.

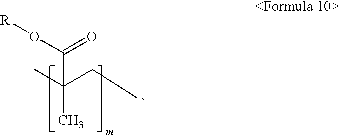

where R is one of Formulas 11 through 18 below, and m is an integer of 50 to 500.

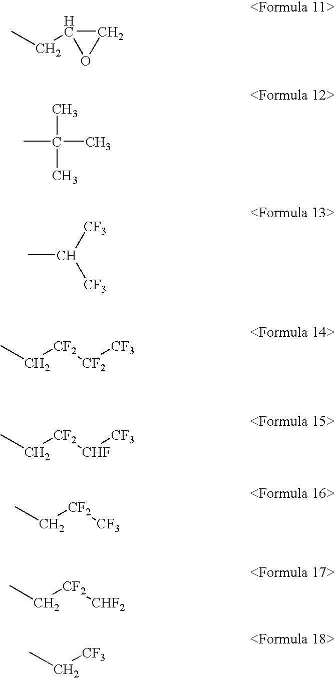

The grating layer may comprise a thin layer formed of a material having the second refractive index and a diffraction lattice layer formed of the same material as the thin layer. The thickness of the thin layer may be 0 to 300 nm. 8. The depth of recesses of the diffraction lattice layer may be 100 to 500 nm.

A capture material of a target biomaterial may be immobilized on a surface of the grating layer.

A spectrum of light reflected by the resonant reflective filter may be symmetric.

The pitch of a grating of the grating layer may be shorter than the average wavelength of a light source irradiated to the resonant reflective filter.

According to another aspect of the present invention, there is provided a biosensor comprising the resonant reflective filter.

### DESCRIPTION OF DRAWINGS

The above and other features and advantages of the present invention will become more apparent by describing in detail exemplary embodiments thereof with reference to the attached drawings in which:

FIG. 1 illustrates a reflective spectrum formed using a conventional resonant reflective filter;

FIGS. 2A and 2B are a cross-sectional view and a perspective view, respectively, illustrating a resonant reflective filter according to an embodiment of the present invention;

FIGS. 3A and 3B are perspective views illustrating resonant reflective filters according to other embodiments of the present invention;

FIG. 4 is a side cross-sectional view of a resonant reflective filter according to another embodiment of the present invention;

FIG. 5 is a partial cross-sectional view showing the sizes of portions of the resonant reflective filter of FIGS. 2A and 2B; and

FIGS. 6 through 8 illustrate spectrums formed using a resonant reflective filter according to an embodiment of the present invention.

### BEST MODE

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals denote like elements, and various elements and regions in the drawings are illustrated schematically. Accordingly, the present invention is not limited by the relative sizes or distances illustrated in the attached drawings.

According to an embodiment of the present invention, a resonant reflective filter is formed of a substrate having a first refractive index; and a grating layer having a second refractive index that is formed on the substrate. The second refractive index is greater than the first refractive index.

As it was mentioned above, asymmetry of the spectrums decreases signal-to-noise ratio due to the increase of the background noise of signals. We found that the asymmetry is caused mainly by the difference in the refractive indices of materials respectively contacting two opposing sides of the diffraction lattice forming a resonant reflective filter. That is, when the refractive index of a substrate material contacting one side of the diffraction lattice and that of a solution contacting the other side of the diffraction lattice are remarkably different from each other, the asymmetry is caused.

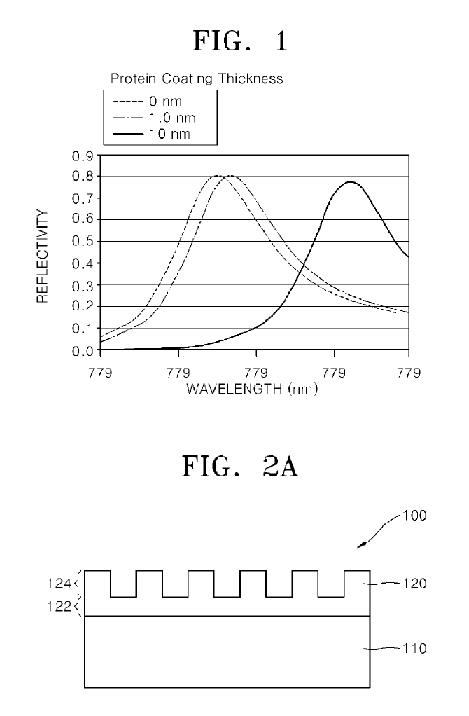

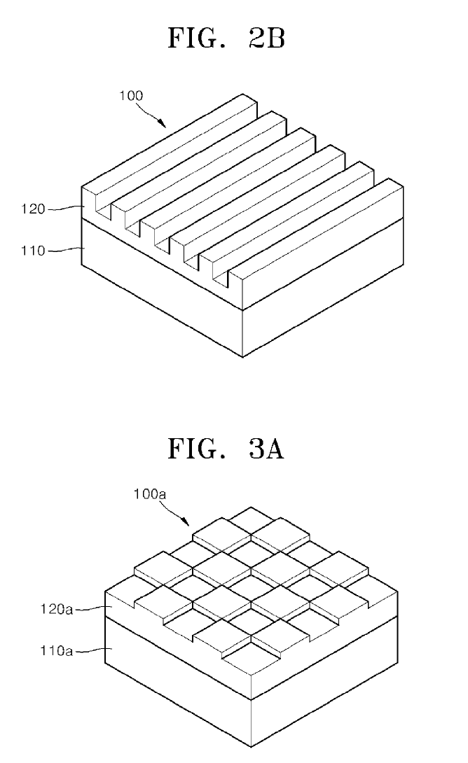

FIG. 2A is a side cross-sectional view of a resonant reflective filter 100 according to an embodiment of the present invention. FIG. 2B is a perspective view of the resonant reflective filter 100. Referring to FIG. 2A, the resonant reflective filter 100 according to the current embodiment of the present invention includes a grating layer 120 formed on a substrate 110 having a first refractive index. The grating layer 120 has a second refractive index which is greater than the first refractive index. The grating layer 120 includes a thin layer 122 and a diffraction lattice layer 124.

The first refractive index may be 1.24 to 1.38. The first refractive index may preferably be similar to the refractive index of a material contacting a surface of a biosensor including the resonant reflective filter 100. If the material contacting the surface of the biosensor is a solution such as serum or phosphate-buffered saline (PBS) containing biomaterials such as protein, DNA, cell, etc., the substrate 110 may be formed of a material having a refractive index the same as or the most similar to that of the solution considering the refractive index of the solution.

Accordingly, the substrate 110 may be formed of MgF₂ having a refractive index of 1.35 considering the above, but the present invention is not limited thereto. For example, the substrate 110 may also be formed of a fluoro-based resin such as polytetrafluoroethylene (PTFE), or polymethylmethacrylate (PMMA). Alternatively, the substrate 110 may be formed of a polymer resin that is obtained by respectively polymerizing a monomer having a structure of any one of Formulas 1 through 6 below.

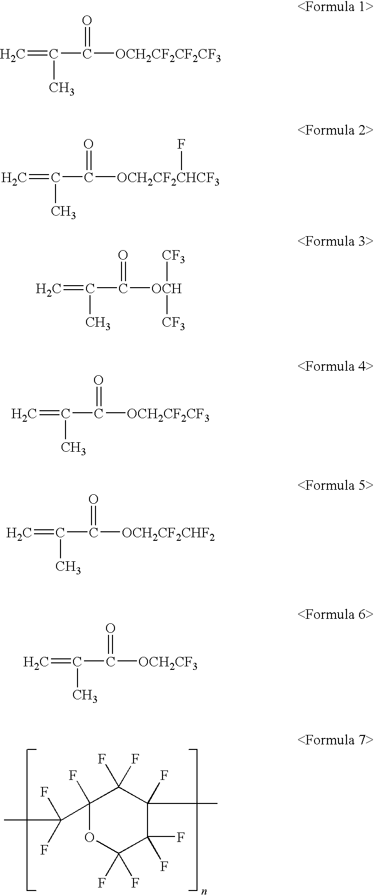

where n is an integer of 100 to 500.

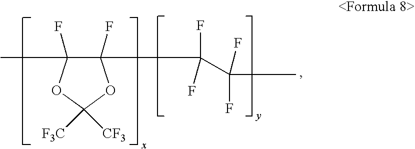

where x and y are integers of 50 to 300, respectively.

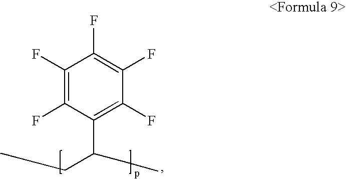

where p is an integer of 50 to 500.

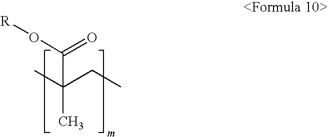

where R is one of Formulas 11 through 18 below, and m is an integer of 50 to 500.

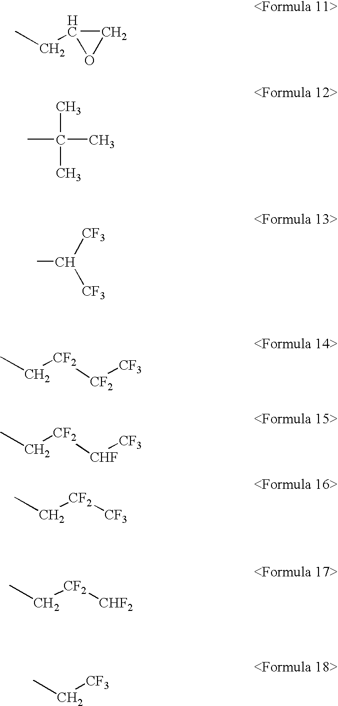

The substrate 110 may particularly be formed of a material in which at least one of the repeating structure of Formula 9 and the repeating structure of Formula 10 are block-copolymerized, or a material in which repeating structures of Formula 10 having various R values are block-copolymerized. For example, Formula 10 may be a material in which a repeating structure having an R value of Formula 11 and a repeating structure having an R value of Formula 12 are block-copolymerized. However, the material is not limited thereto.

The materials that can be used to form the substrate 110 listed above are examples and are not limited thereto. The substrate 110 for the current embodiment of the present invention may be formed of any material having a refractive index of 1.24 to 1.38 and satisfying other conditions. However, the refractive index of the substrate 110 and the refractive index of a sample contacting a surface of the grating layer 120 included in the resonant reflective filter 100 may preferably be similar to each other, the surface being opposite to the substrate 110.

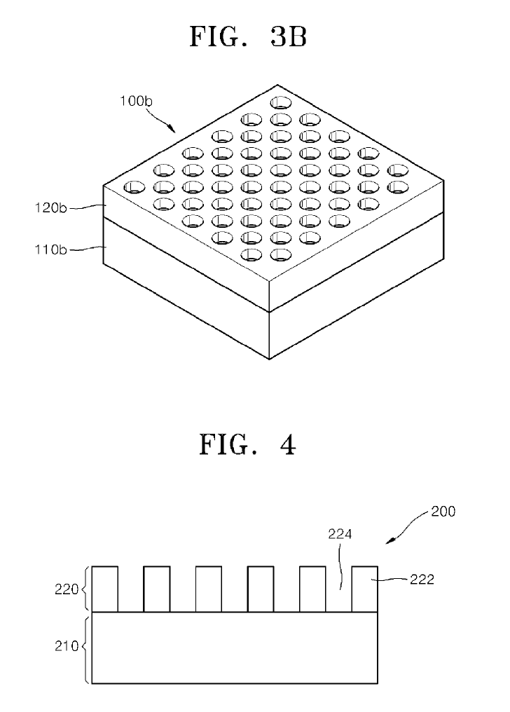

The grating layer 120 includes the thin layer 122 on which the diffraction lattice layer 124 is formed linearly as illustrated in FIG. 2B, but the present invention is not limited thereto. The grating layer 120a and 120b formed on the substrate 110a and 110b of the resonant reflective filter 100a and 100b may have a square grid structure as in FIG. 3A or a structure of holes arranged in diagonal formation as illustrated in FIG. 3B.

The grating layer 120 comprises a thin layer 122 formed of a material having the second refractive index and a diffraction lattice layer 124 formed of the same material as the thin layer 122.

FIG. 4 is a side cross-sectional view of a resonant reflective filter 200 according to an embodiment of the present invention. Referring to FIG. 4, the resonant reflective filter 200 according to the current embodiment of the present invention includes a substrate 210 and a grating layer 220. The grating layer 220 may have recesses 224 that are completely opened such that portions of the substrate 210 are exposed. That is, a thin layer may selectively be omitted in the grating layer 220.

As described at the beginning of the specification, the second refractive index of a material forming the grating layer is greater than the first refractive index. The second refractive index may be 1.4 to 2.5. The grating layer may be formed of a polymer resin such as polypropylene, polystyrene, polycarbonate, etc. or, SiO₂, SiNₓ, TiO₂, but is not limited thereto.

The resonant reflective filter 100 and 200 forms a resonant spectrum as light diffracted by a diffraction lattice layer is waveguided through a light waveguide having a high refractive index.

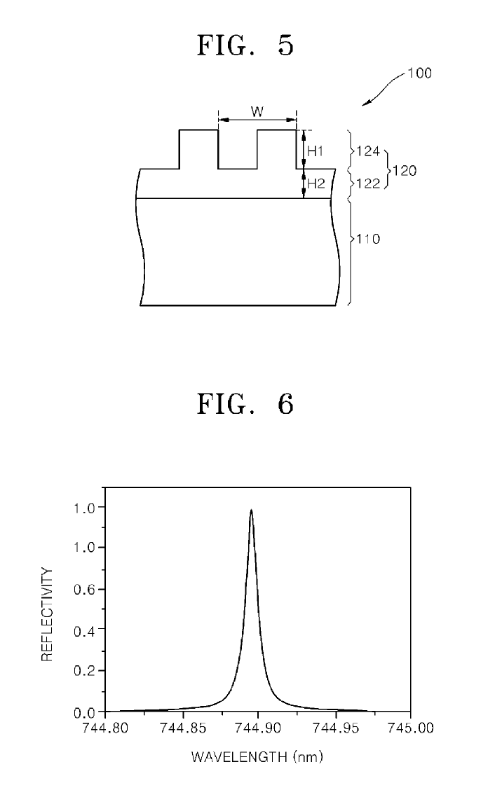

FIG. 5 is a partial cross-sectional view showing the sizes of portions of the resonant reflective filter 100 of FIGS. 2A and 2B. A pitch W of a grating forming the grating layer 120 in the resonant reflective filter 100 is shorter than an average wavelength of a light source irradiated to the resonant reflective filter 100. If the pitch W is longer than the average wavelength of the light source, resonant reflection is not easily generated, and thus the pitch W of the grating may preferably be shorter than the average wavelength of the light source irradiated to the resonant reflective filter 100.

Also, a depth H1 of recesses of the diffraction lattice layer 124 may be 100 to 500 nm, and a thickness H2 of the thin layer 122 may be 0 to 300 nm. FIG. 4 illustrates a case in which the grating layer 220 does not include a thin layer. In other words, the thickness of a non-existent thin layer of the grating layer 200 is 0 nm.

When the depth H1 of the recesses of the diffraction lattice layer 124 is less than 100 nm or the thickness H2 of the thin layer 122 exceeds 300 nm, the total thickness of the grating layer 120 is extended, and the ratio of the diffraction lattice layer 124 in the grating layer 120 is decreased accordingly, which may cause undesirable characteristics.

Also, when the depth H1 of the recesses of the diffraction lattice layer 124 exceeds 500 nm, a resonant reflection peak may hardly be generated, and the performance of the resonant reflective filter 100 may be degraded due to the light absorption of the material forming the diffraction lattice layer 124 itself.

The grating layers 120 and 220 can be manufactured in various ways. For example, a layer having a thickness H1+H2 of the grating layers 120 and 220 may be formed on a substrate, and then the layer is etched or nano-imprinted by optical lithography to form recesses. This technology is well known in the art, and thus a description thereof is not provided here.

When the resonant reflective filter 100 is used in a biosensor, a capture biomaterial may be immobilized on a surface of the resonant reflective filter 100. The capture biomaterial is a material that is capable of capturing a material to be detected that is present in a sample by applying an antigen-antibody reaction, and can be selected according to the purpose of use. For example, the capture biomaterial may be an amine-based material, an aldehyde-based material, or nickel, but is not limited thereto.

The capture biomaterial may be immobilized on the grating layer using conventional methods.

A biosensor including the resonant reflective filter 100 and 200 according to an embodiment of the present invention is operating as follows.

A target biomaterial present in a sample solution is captured by a capture biomaterial that is immobilized on the grating layer 120 and the thickness and the refractive index of a surface layer of the biosensor are changed. This change changes the position of a peak in a reflective spectrum of the resonant reflective filter 100 and 200, and the presence or non-presence of the target biomaterial is sensed from the change of the peak position.

FIG. 6 illustrates a reflection spectrum of a resonant reflective filter in which the refractive index of a substrate of the resonant reflective filter and the refractive index of a sample solution are almost the same. The result of FIG. 6 was obtained when the refractive index of the substrate was 1.35, the refractive index of a grating layer of the resonant reflective filter was 1.5, the refractive index of the sample solution was 1.34, and the thickness of a thin layer of the grating layer was 20 nm, the height of a diffraction lattice layer of the grating layer was 200 nm, the pitch of the grating was 550 nm, and the wavelength of irradiated light was 744.9 nm.

Referring to FIG. 6, the peak of the spectrum is not only very sharp, but is also almost completely horizontally symmetrical. Accordingly, portions of the spectrum that may constitute background noise are reduced, thereby increasing the signal-to-noise ratio of the biosensor and thus improving its sensitivity. The resonant reflective filter of the present invention can be applied to biosensors, and also any fields requiring a filter having an intense and narrow bandwidth. For example, the resonant reflective filter can be applied to optical systems that require a narrow-line, such as narrow-line polarized lasers, tunable polarized lasers, photorefractive tunable filters, electro-optic switches, etc.

Meanwhile, the spectrum illustrated in FIG. 1 is when the refractive index of a substrate of a conventional resonant reflective filter and the refractive index of a sample solution differ greatly from each other. Here, a SiN grating having a refractive index of 2.01 was formed on a glass substrate having a refractive index of 1.5, and the height of a diffraction lattice layer of a grating layer of the resonant reflective filter was 180 nm, and the pitch of the grating was 510 nm. As illustrated in FIG. 1, the spectrum was intensely asymmetric, and such an asymmetric spectrum increases the noise level up to about 0.15, thereby decreasing the signal-to-noise ratio. Accordingly, the sensitivity of the biosensor was degraded.

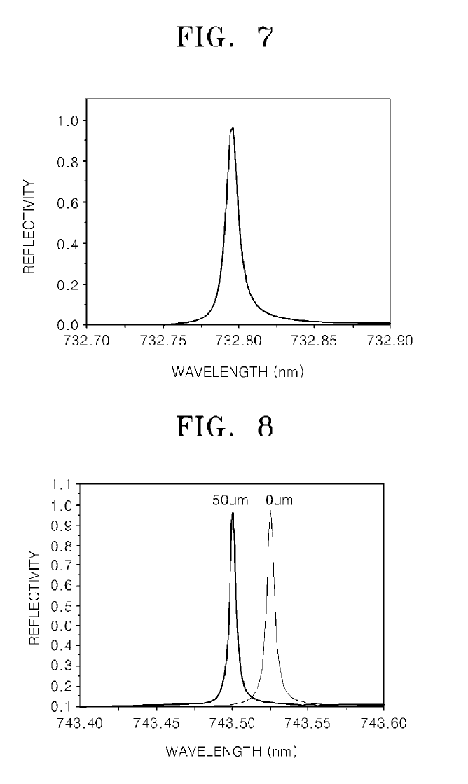

FIG. 7 is a reflection spectrum of a resonant reflective filter when the refractive index of a substrate of the resonant reflective filter and the refractive index of a sample solution differ from each other to some extent. The parameters used to obtain the reflection spectrum of FIG. 7 were the same as those of FIG. 6 except that the refractive index of the substrate was 1.25.

As can be seen from FIG. 7, although the symmetry of the spectrum is decreased slightly, the spectrum of FIG. 7 is more symmetric than that of FIG. 1 and the peak of the spectrum still has a sharp shape. Thus, it can be deduced that the sensitivity of the resonant reflective filter is also improved significantly.

FIG. 8 illustrates a change in reflection spectrums obtained by varying the thickness of a thin layer of a grating layer of a resonant reflective filter. The parameters used to obtain the reflection spectrums of FIG. 8 were the same as those of FIG. 6 except that the thickness of the thin layer was 0 nm and 50 nm, respectively. As can be seen from FIG. 8, the position of a peak of a spectrum can be adjusted by controlling the parameters of the resonant reflective filter, such as the thickness of the thin layer with reference to the spectrum of irradiated light, and by this, a more efficient resonant reflective filter can be manufactured.

The resonant reflective filter according to the present invention can be applied to optical systems that require a small linewidth, and moreover, a biosensor having excellent sensitivity compared to a conventional biosensor can be manufactured.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A resonant reflective filter comprising:
a substrate having a first refractive index; and
a grating layer formed on the substrate and having a second refractive index,
wherein the second refractive index is greater than the first refractive index.

2. The resonant reflective filter of claim 1, wherein the first refractive index is 1.24 to 1.38.

3. The resonant reflective filter of claim 1, wherein the substrate comprises at least one of the group consisting of polytetrafluoroethylene (PTFE), polymethyl methacrylate (PMMA), polymer resin obtained by polymerizing monomers having a structure of any one of Formulas 1 through 6 below, a polymer material having a repeating structure of any one of Formulas 7 through 10 below, a polymer material in which the repeating structure of Formula 9 and the repeating structure of Formula 10 are block-copolymerized, and a polymer material in which repeating structures having different R values of Formula 10 are block-copolymerized. 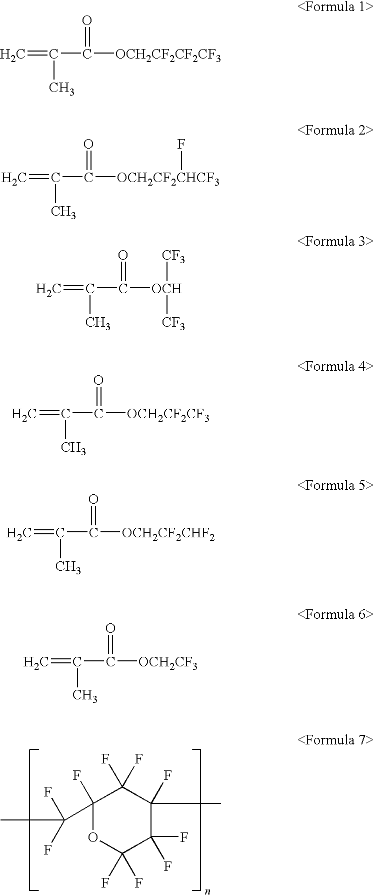
where n is an integer of 100 to 500. 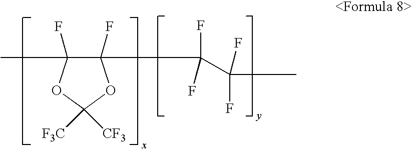
where x and y are integers of 50 to 300, respectively. 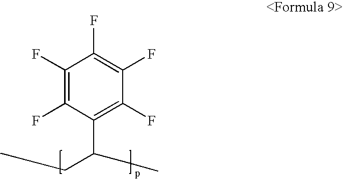
where p is an integer of 50 to 500. 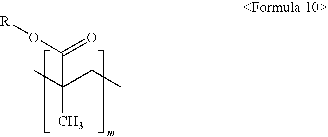
where R is one of Formulas 11 through 18 below, and m is an integer of 50 to 500.

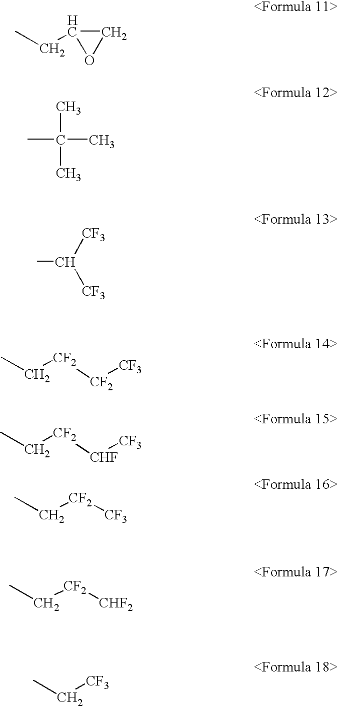

4. The resonant reflective filter of claim 1, wherein the second refractive index is 4 to 2.5.

5. The resonant reflective filter of claim 1, wherein the grating layer comprises a thin layer formed of a material having the second refractive index and a diffraction lattice layer formed of the same material as the thin layer.

6. The resonant reflective filter of claim 5, wherein the thickness of the thin layer is 0 to 300 nm.

7. The resonant reflective filter of claim 1, wherein a capture material of a target biomaterial is immobilized on a surface of the grating layer.

8. The resonant reflective filter of claim 5, wherein the depth of recesses of the diffraction lattice layer is 100 to 500 nm.

9. The resonant reflective filter of claim 1, wherein a spectrum of light reflected by the resonant reflective filter is symmetric.

10. The resonant reflective filter of claim 1, wherein the pitch of a grating of the grating layer is shorter than the average wavelength of a light source irradiated to the resonant reflective filter.

11. A biosensor comprising the resonant reflective filter of claim 1.
